(19) United States
(12) Patent Application Publication
(10) Pub. No.: US 2005/0249048 A1
(43) Pub. Date: Nov. 10, 2005

(54) Childhood time-keeping device with parental control

(76) Inventors: Angela Marie Lothrop, Lakeville, MN (US); Lisa Kay Lothrop, Seattle, WA (US)

Correspondence Address: Lisa Lothrop, 3315 56th Avenue Southwest, Seattle, WA, 98116, US

(21) Appl. No.: 10/837,592

(22) Filed: May 4, 2004

(51) Int. Cl. G04B 19/00; G04C 21/00; G08B 1/00; G04C 17/00

(52) U.S. Cl. 368/223

(57) ABSTRACT

A child's time-keeping device for both positive reinforcement and time-out behavioral modification. This time-keeping device includes a timer. The before said timer controls an object that moves from a beginning point to an end-point. This object will show with movement the amount of time remaining. The amount of time can be changed with age or per individual child. The device has a remote that controls before said object.

### CROSS-REFERENCE TO RELATED APPLICATIONS

U.S. 20040067713 Apr. 8, 2004 Fong
U.S. 20030210613 Nov. 13, 2004 Block
U.S. 20040048229 Mar. 11, 2004 Thurman
U.S. Pat. No. 6,589,058 Jul. 8, 2003 Brooks
U.S. Pat. No. 5,684,758 Nov. 4, 1997 Gray
U.S. Pat. No. 5,044,961 Sep. 3, 1991 Bruskewitz
GB 2369200 May 22, 1990 Freemantle
WO 9002505 Mar. 22, 1990 Canovas
U.S. Pat. No. 4,373,918 Feb. 15, 1983 Berman

### STATEMENT REGARDING FEDERALLY SPONSORED RESEARCH OR DEVELOPMENT

Not Applicable

### REFERENCE TO SEQUENCE LISTING

Not Applicable

### FIELD OF INVENTION

The present invention relates to a child's time-keeping device used for positive behavior “play-time” or negative behavior, “time-outs.” This invention also helps the child to visually conceptualize time, while allowing the parent, or caregiver, the ability to remotely alter length of before said time allotments.

### BACKGROUND OF THE INVENTION

The time-out disciplinary process has gained wide scale acceptance for children between the ages of 2 and 11. The concept of the time-out is to immediately remove the child from the negative activity and place the child in an area where the child can return to normal behavior. The age or the individual child directly affects what the overall length of time that the child should remain in the “time-out.”

The timer is set for a specific amount of time and if the child continues to act in an unacceptable manner, the caregiver must manually stop, start or reset the clock until the inappropriate behavior has ended.

In addition, the time keeping devices of today do an excellent job of keeping time, but young children do not know how time is kept and no end point can be seen, further frustrating the child.

### SUMMARY OF THE INVENTION

The aforementioned problems have been resolved in the present invention wherein a child's time-keeping device that includes: a timer, a remote control, and an object that visibly shows the time remaining.

The present device contains a timer that allows the parent or caregiver the ability to change the amount of time based on the activity, child and/or age.

The present invention also allows the caregiver to have control over the device. This control is achieved by the accompaniment of a remote control. The remote allows the caregiver to stop, start, or reset the time depending on the behavior of the child without interaction with the child. A real world example of this would be; if an inappropriate behavior continued to occur the remote would allow the parent or caregiver the opportunity to start the time only when the child has calmed down and is quiet.

In addition, if during the “time-out,” the child begins the inappropriate behavior again, the parent or caregiver can stop or rewind the time depending on the situation. In addition, this product may also be used as a way for the child to understand the concept of time during activities such as; quiet time, play time, etc . . . Thus allowing this device to be used as a positive reinforcement tool.

Because, young children, from two to five years of age, lack the ability to tell time, the device shows the time remaining in an easy to understand depiction of time. As an example of, but not limited to, an automobile, that will show it beginning at a specific point and ending at a specific location. This object will show with movement the amount of time remaining. This typically will be, but not limited to, an arc as described in the following drawing. Once the end-point has been reached, a sound will indicate that the established time period has expired. The amount of time can be changed with the activity, age or per individual child. This current invention allows the child to view the time remaining in a very simplistic manner.

### BRIEF DESCRIPTION OF THE DRAWING

FIG. 1 is a frontal elevation view of one embodiment of the article of commerce.

FIG. 2 is a rear view of the article of commerce.

FIG. 3 is a top view of the article of commerce.

### DETAILED DESCRIPTION OF THE INVENTION

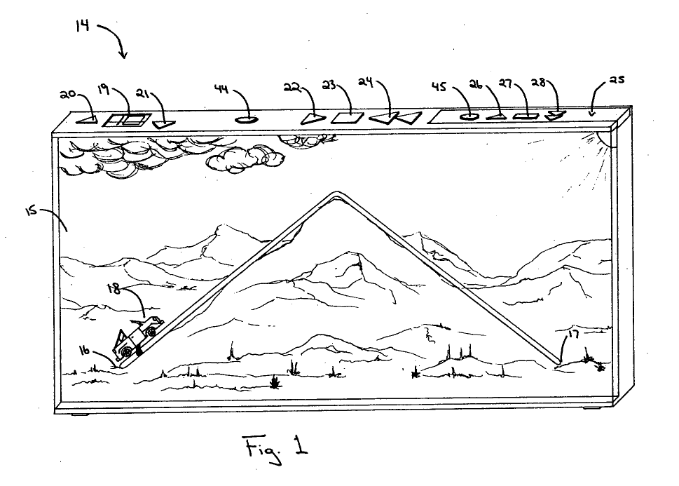

Referring to the detail of FIG. 1 the frontal elevation view. The number 14 is the general embodiment of the overall device, which may be comprised of plastic, metal, or other material. The means of control over the device are the remote 25, (which consists of a power 45, start 26, stop 27, and rewind 28 button) and the power 44, start 22, stop 23, and rewind button 24 located on the physical device 14. There is an up arrow 20 and a down arrow 21 that controls the digital time readout 19. The object 18 is viewed through a plastic or clear piece 15 that shows the object 18 moving from a beginning point 16 to an end-point 17.

The remote 25 in FIG. 1 is wireless and controls the object 18. The remote 25 is comprised of a power button 45, start button 26 which begins the object 18, a stop button 27 which will pause or stop the object 18, and a rewind button 28 that will allow the object 18 to reverse or return to beginning point.

An additional means of control in FIG. 1 are the power button 44, play button 22, stop button 23 and the rewind button 24 that are located on the top portion of the device 14. These features control the object 18 the same as previously described with the remote.

The means of controlling the time allotments in FIG. 1 are the up arrow 20 which increases the time in the overall period, and the down arrow 21 which decreases the amount of time. Both the up arrow 20 and the down arrow 21 directly effects the digital display 19 that shows the duration of time for this time period.

In FIG. 1 the object 18 is shown as but not limited to an automobile. The moving parts are located behind a viewable plastic shield 15 that prevents children from tampering with or becoming a choking hazard. In addition, this object 18 moves from a beginning point 16 to an end-point 17. This will show the time remaining visually verses numerically as with most timing devices.

The rear view of the device 14 in FIG. 2 shows the attachment hooks 29, the feet 31, the speaker 32, and the battery compartment 30.

The attachment hooks in FIG. 2 enables the device 14 to be hung on a wall. The feet 31 allow the device 14 to be placed on a table. The speaker 32 is shown as, but not limited to the rear of the device. The battery compartment 30 is the storage area for the power source of the device.

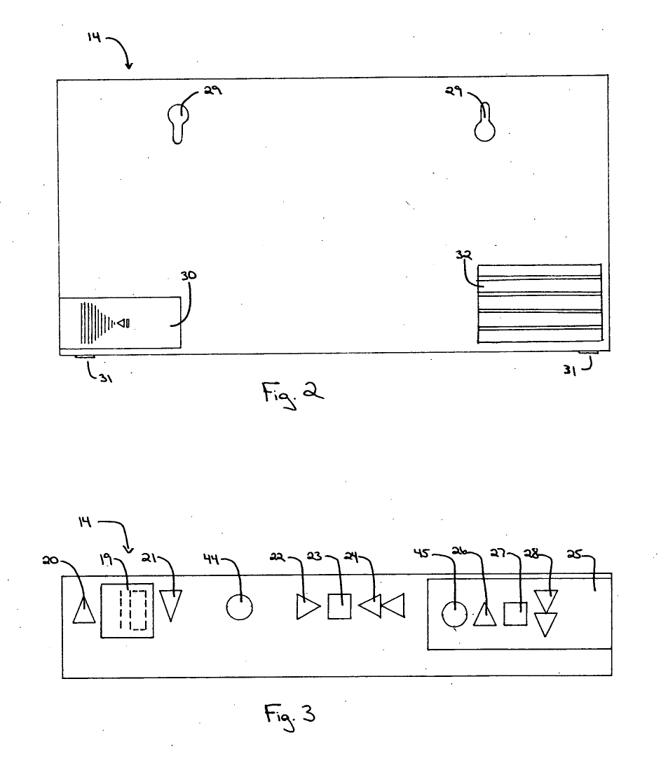

The view of the device 14 in FIG. 3 is the top view of the device 14. This shows alternative view of the invention with all features that were previously described in FIG. 1.

The above embodiments of the current invention are deemed as merely illustrative and not restrictive. Various changes may be made without deviating from the spirit thereof. The present invention is therefore limited only by the scopes of the following appended claims.

1. A child's time-keeping device.

2. A child's time-keeping device as defined in claim 1 wherein said device contains a timer.

3. A child's time-keeping device as defined in claim 1 wherein said device contains an object that moves from a beginning point to an end-point.

4. A child's time-keeping device as defined in claim 1 wherein said device can be controlled by a remote control.

5. A child's time-keeping device as defined in claim 2 wherein said timer is digital.

6. A child's time-keeping device as defined in claim 2 wherein said device features specific time allotments.

7. A child's time-keeping device as defined in claim 3 wherein said object logically show a beginning and an end to the period of time.

8. A child's time-keeping device as defined in claim 3 wherein said object could include, but not limited to an automobile, as shown in drawing.

9. A child's time-keeping device as defined in claim 4 wherein said remote device is wireless.

10. A child's time-keeping device as defined in claim 4 wherein said remote device controls object defined in claim 3.

11. A method of altering before said time allotment as described in claim 6 by mean of the remote device stated in claim 4.

12. A child's time-keeping device as defined in claim 7 wherein said end-point is indicated with sound.
